(19) United States
(12) Patent Application Publication
(10) Pub. No.: US 2017/0067424 A1
(43) Pub. Date: Mar. 9, 2017

(54) Engine Intake Manifold

(71) Applicant: Anna Krogdahl, Cupertino, CA (US)

(72) Inventor: Anna Krogdahl, Cupertino, CA (US)

(21) Appl. No.: 14/798,671

(22) Filed: Jul. 14, 2015

(51) Int. Cl. F02M 35/116; F02M 35/10

(52) U.S. Cl. CPC F02M 35/116; F02M 35/10098; F02M 35/10347

(57) ABSTRACT

An engine intake manifold for a V-type internal combustion engine comprising a plenum, distribution runners and an intake tract mounted between the V-type engine cylinder heads. The intake tract has a front-facing opening for channeling air from the front of the engine into the underside of the plenum, and is configured to fit within the space defined by the underside of the plenum, the distribution runners, and top of the V-type engine block.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to V-type engine intake manifolds. In a specific embodiment, the invention relates to a single plane intake manifold with a lower intake tract for air induction.

Internal combustion engines include an intake manifold to direct air into the cylinder heads and combustion chambers. Inside the combustion chamber, the fuel and air mixture is ignited, releasing energy to power the engine

Engine intake manifolds are typically constructed of a plenum, distribution runners that direct airflow to the engine cylinder heads, and an opening to the plenum for connection of air regulation equipment such as a throttle body or carburetor.

The prior art relating to engine intake manifolds contains numerous examples of V-type intake manifolds with top-facing openings. One embodiment typically known as a single plane intake manifold, utilizes a single centralized plenum with a top-facing opening, and distribution runners that direct the air to the two cylinder heads.

Historically, single plane intake manifolds were used with carburetors, for air and fuel regulation, to facilitate horizontal mounting of the carburetor on top of the intake manifold. Such configuration facilitated airflow into the top-facing opening of the plenum.

Due to the transition of the automotive industry from carburetion to throttle bodies and injected fuel systems and due to space restrictions under an automotive hood, many intake manifolds are designed with front-facing openings to the intake manifold plenum. The front facing opening allows connection of a throttle body to regulate airflow, whilst maintaining a low overall height to provide hood clearance.

Single plane intake manifolds with top-facing plenum openings offer advantages over front-facing plenum openings, being uniform air distribution to the runners, low turbulence and less restrictive runners due to straighter runner shape.

Intake manifolds with front-facing plenum openings typically provide airflow to the front distribution runners before feeding the rear runners, resulting in uneven airflow into the engine. This is undesirable, as the various combustion chambers of the engine can experience differing air/fuel ratios, resulting in reduced engine power and potential for engine damage. In addition, the arrangement and shape of the runners can result in higher restriction and increased turbulence, reducing engine power.

It is the principle object of this invention to provide an improved engine intake manifold that combines the performance benefits of an intake manifold with a top-facing plenum opening, with the ease of installation and hood clearance of an intake manifold with a front-facing plenum opening.

The limitations and non-effectiveness of the prior art has been overcome by the instant invention as described below.

### BRIEF SUMMARY OF THE INVENTION

The invention provides an improved engine intake manifold, applicable to V-type internal combustion engines. The intake manifold provides uniform distribution of air to the distribution runners and facilitates a front facing throttle body.

In preferred form, the intake manifold includes a plenum mounted centrally between the V-type engine cylinder heads with distribution runners connecting the plenum to the cylinder heads. The intake manifold includes an intake tract with a front-facing opening and is connected to the underside of the plenum via a bottom-facing plenum opening. The intake tract is bounded by the underside of the plenum, distribution runners and engine valley and this space is optimized to maximize the volume of the intact tract

A connection for a throttle body, for air regulation, is provided at the front-facing opening of the intake tract.

In preferred form, the plenum has both top-facing and bottom-facing plenum openings. In the intended application, the top-facing plenum opening is blocked by means of a plate connected to the plenum.

In preferred form, the manifold is constructed of two major sections, being the intake manifold and the intake tract, individually molded or fabricated and machined, including a lid for blocking the top-facing plenum opening. The parts are connected to form an enclosed intake manifold with a front-facing opening.

Another form of the invention includes the intake manifold and intake tract being cast, molded or fabricated as a single unit. The resultant intake manifold would not allow separation of the intake tract from the intake manifold.

These and other features, objects and advantages of the present invention will be readily apparent to persons of ordinary skill in the art upon reading the entirety of this disclosure, which includes the accompanying drawings and claims.

### BRIEF DESCRIPTION OF THE SEVERAL VIEWS OF THE DRAWING

FIG. 1 is a pictorial view of the invention applied in an eight cylinder V-type engine.

FIG. 2 is an exploded view of an embodiment of the intake manifold in accordance with aspects of the present invention

FIG. 3 is a side view of the invention

FIG. 4 is a top view of the intake manifold

FIG. 5 is a front view of the intake manifold

FIG. 6 is a top view of the intake manifold with the top lid removed to show the internal features of the plenum.

FIG. 7 is a cross-sectional view, along line X-X represented in FIG. 4, showing the plenum with the intake tract connected to the bottom-facing opening of the plenum.

FIG. 8 is a cross-sectional view of the intake manifold, along line Y-Y represented in FIG. 4, showing the space for the intake created under the plenum and distribution runners.

### DETAILED DESCRIPTION OF THE INVENTION

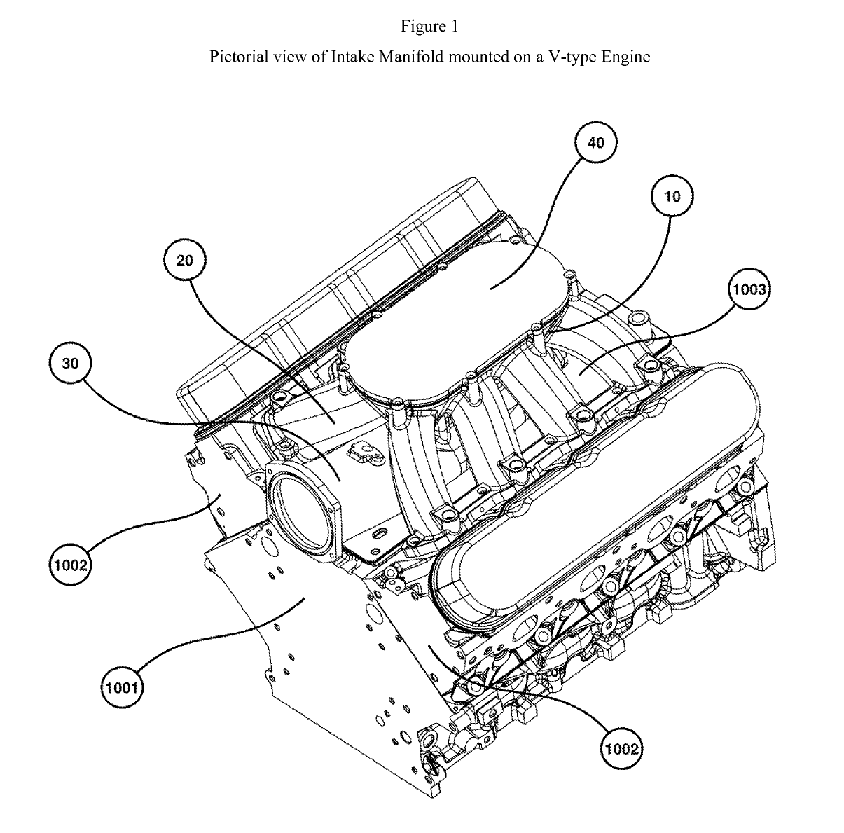

FIG. 1 shows an exemplary intake manifold assembly 10 for an eight-cylinder V-type engine 1001 in accordance with aspects of the present invention. However, it is understood that aspects of the invention are applicable to V-type engines having any number of cylinders. The intake manifold assembly consists of a plenum 10, top lid 40, individual runners 20, and an intake tract 30. Plenum 10 is positioned centrally between the two V-type cylinder heads 1002 and runners 20 connect the plenum 10 to the cylinder heads 1002. The intake tract 30 is bounded by the valley cover 1003 of the V-type engine 1001, the runners 20, and the bottom of the plenum 10.

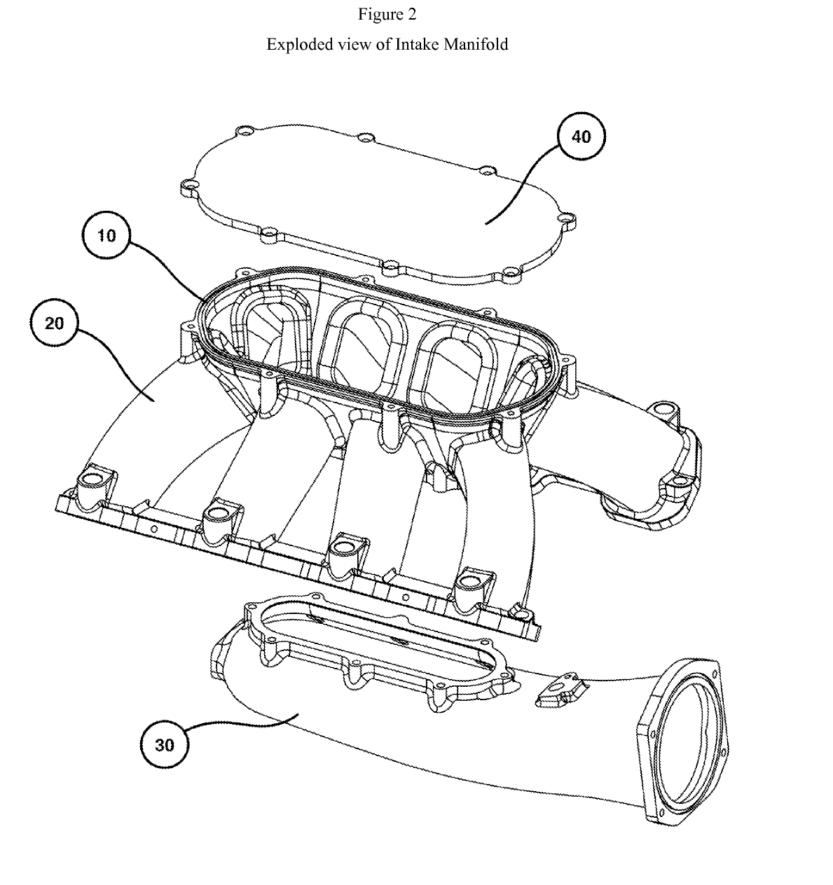

FIG. 2 shows an exploded view of the exemplary intake manifold assembly, including a plenum 10, runners 20, top lid 40 attached to the top of the plenum, and an intake tract 30 attached to the bottom of the plenum 10.

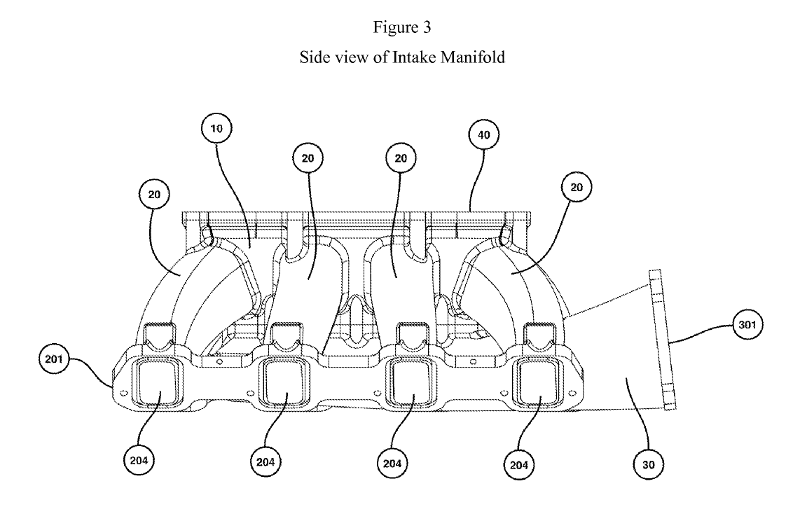

FIG. 3 shows a representation of a side view of the intake manifold. The intake tract 30 has a throttle body mounting flange 301, with a front-facing opening, to facilitate attachment of a front-facing throttle body. Openings 204 in the cylinder head mounting flange 201 allow air to transition from the runners 20, into the engine cylinder heads.

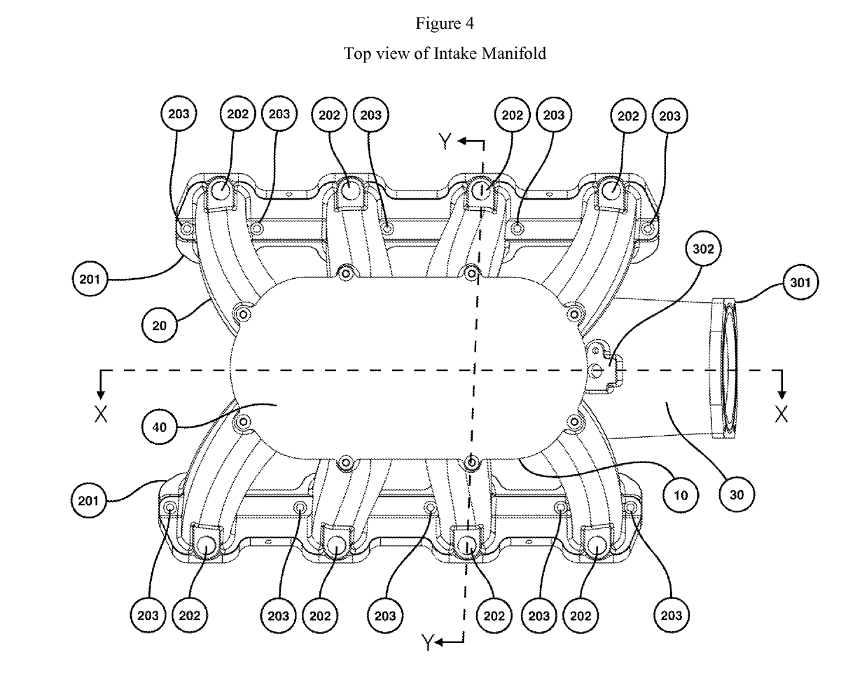

FIG. 4 shows a top view of the intake manifold assembly. For an eight-cylinder V-type engine, there are eight runners 20, with one or more injector ports 202 on each runner. The injector ports 202, facilitate the mounting of devices used to inject fuel or other liquids or gases into the individual engine cylinders. Cylinder head mounting flanges 201 contain fastener locations 203 to attach the intake manifold to the engine cylinder heads. The intake tract 30 extends horizontally outward, in the forward direction, from the plenum 10 to allow mounting of the throttle body on the throttle body mounting flange 301 with front-facing opening. On the exemplary intake tract, provision has been made to accommodate an air pressure sensor 302.

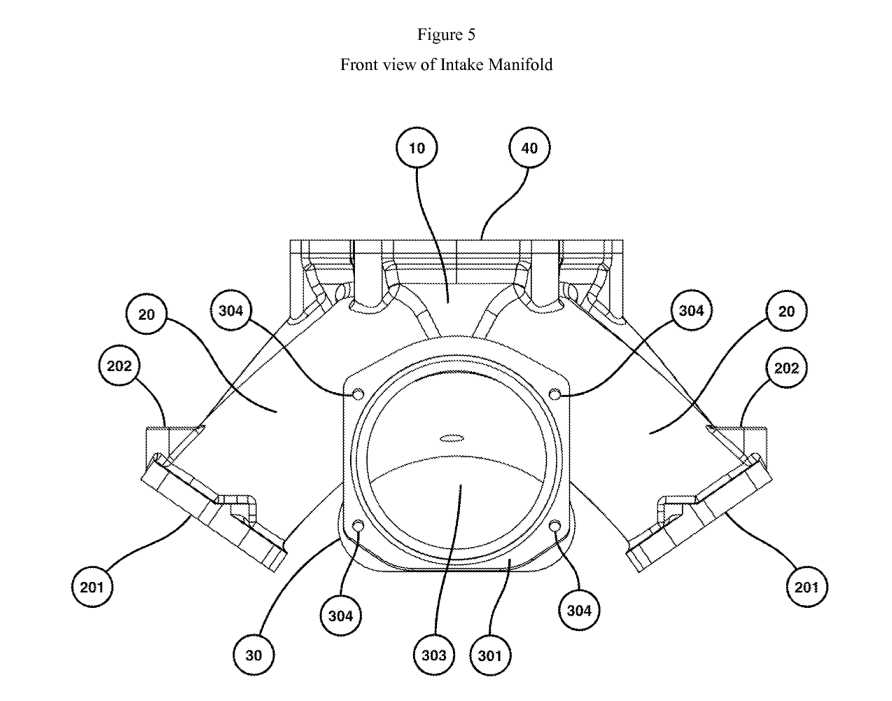

FIG. 5 shows a front view of the intake manifold assembly. The opening 303 of the intake tract 30 can be configured to face towards the front or rear of the engine, by re-configuration of the cylinder head mounting flanges 201 and fasteners 203 used to fasten the intake manifold to the engine cylinder heads. The throttle body mounting flange 301, on the front-facing opening of the intake tract, contains mounting points 304 to facilitate fixing a throttle body to regulate airflow into the intake tract 30. Other intake manifold configurations are possible, including removal of the intake tract 30, blocking the bottom-facing plenum opening by means of a lid, and re-configuring the lid 40 to accommodate a top-facing throttle body mounting flange.

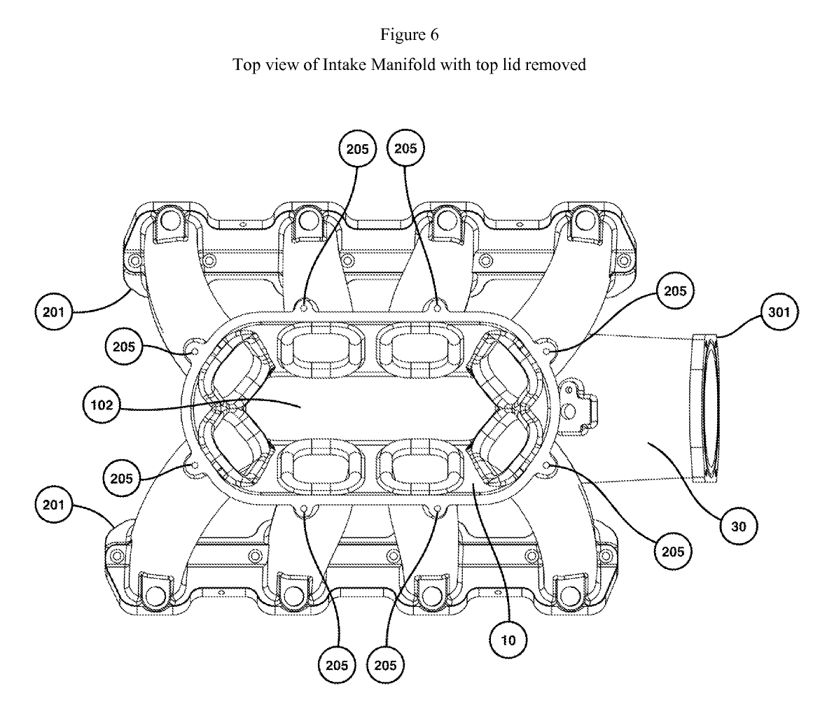

FIG. 6 shows a top view of the intake manifold with the top lid 40 removed to expose the inner features of the plenum 10. The top lid 40 is attached to the plenum 10 by means of fasteners located at one or more fastener locations 205 on the top of the plenum. The top-facing opening 102 facilitates attachment of a blocking lid, or other types of lids to accommodate various downward facing throttle bodies or carburetors.

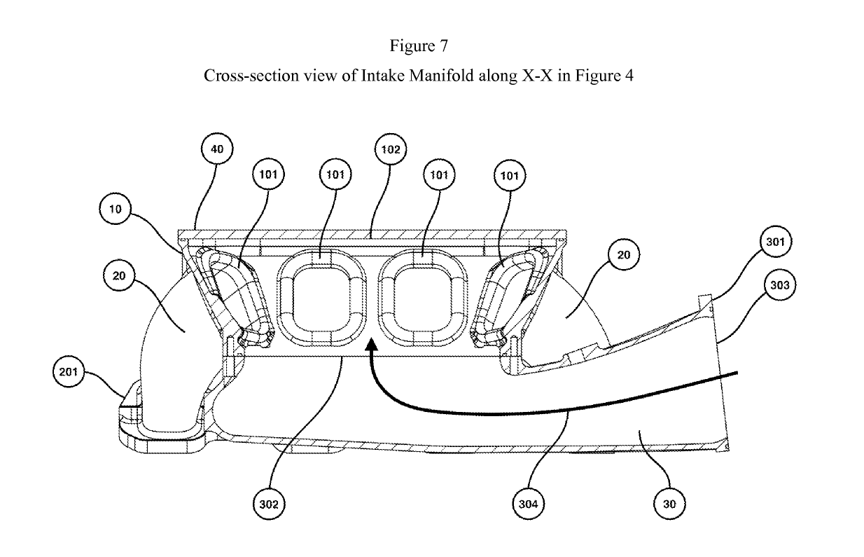

FIG. 7 is a cross-sectional view of the intake manifold along line X-X represented in FIG. 4. After regulation of air by a throttle body attached to the throttle body mounting flange 301, it is shown that the air can freely travel through the front-facing opening 303 in the intake tract 30, into the plenum 10 via the bottom-facing opening 302. Plane 302 represents the bottom-facing opening to the plenum, and connection point of the intake tract 30, to the underside of the plenum 10. After the air has entered the plenum 10, it is distributed to the runners 20 via plenum ports 101, and travels down the runners 20 and into the engine cylinder heads. Arrow 304 is a representation of the directional airflow passing through the intake tract 30 and into the plenum 10.

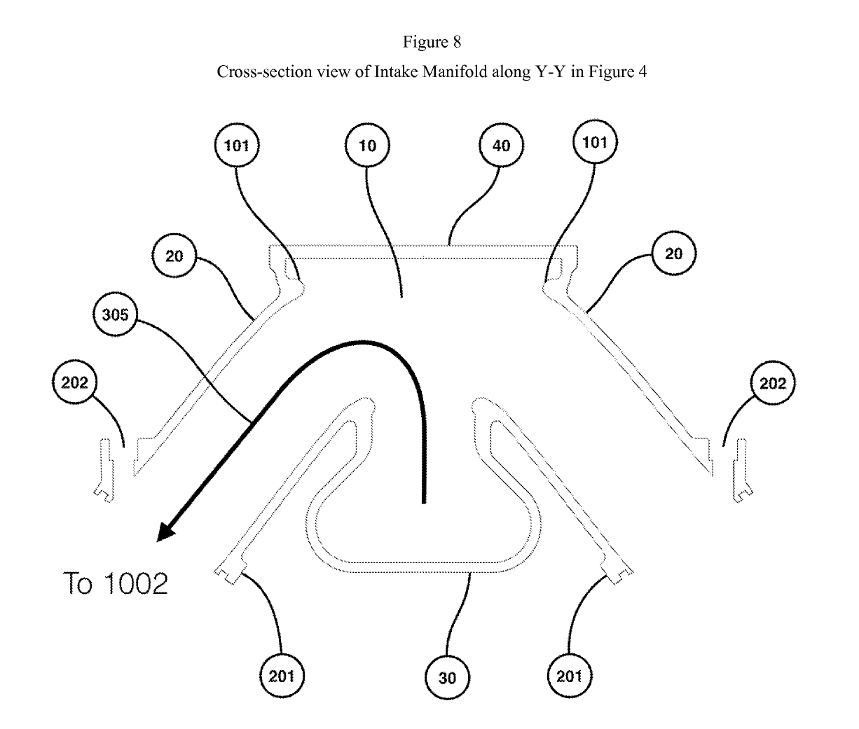

FIG. 8 is a cross-sectional slice of the intake manifold along line Y-Y represented in FIG. 4. The cross-section shows the air volume contained within the lower intake tract 30, the plenum 10 and the runners 20. One or more injector ports 202 may be formed into each of the runners 20, to facilitate passage of gasses and liquids being injected into the air path. Arrow 305 shows the airflow path as it exits the intake tract 30 and flows in an upward direction into the plenum 10, through the bottom-facing opening in the plenum. Airflow is distributed from the plenum 10 into the runners 20 via the plenum ports 101. The runners facilitate airflow to the exemplary engine cylinder heads 1002.

While specific embodiments of the present invention have been provided, it is to be understood that these embodiments are for illustration purposes and not limiting. Many additional embodiments will be apparent to persons of ordinary skill in the art reading this disclosure.

What is claimed:

1. An engine intake manifold that combines the performance benefits of straighter runners typically found on intake manifolds with top-facing plenum openings, with the ease of installation and hood clearance of an intake manifold with a front-facing plenum opening.

2. The apparatus in claim 1 comprising: a plenum mounted centrally between the V-type engine cylinder heads, distribution runners connecting the plenum to the cylinder head mounting flanges, and an intake tract with a front-facing opening connected to the underside of the plenum via a bottom-facing opening in the plenum.

3. The apparatus in claim 2 preferably comprising of: intake manifold and intake tract, individually molded or fabricated and machined, and including a top lid for blocking the top-facing plenum opening.

4. The apparatus in claim 2 in another form comprising of: intake manifold and the intake tract, being cast, molded or fabricated as a single unit, and including a lid for blocking the top-facing plenum opening.

5. The apparatus in claim 2 in another form comprising of: intake manifold, intake tract and top lid, being cast, molded or fabricated as a single unit.
